(19) United States
(12) Patent Application Publication
(10) Pub. No.: US 2003/0116955 A1
(43) Pub. Date: Jun. 26, 2003

(54) SEATBELT RETRACTOR MOUNTING APPARATUS

(75) Inventors: Daniel Adin, Alingses (SE); Peter Adolfsson Sr, Hisings Backa (SE); Kristina Stina Jonsell Gunnarsson, Goteborg (SE)

(73) Assignee: Ford Global Technologies, Inc., Dearborn, 48126 (US)

(21) Appl. No.: 10/065,890

(22) Filed: Nov. 27, 2002

(30) Foreign Application Priority Data
Nov. 28, 2001 (EP) 01128229.0

(51) Int. Cl. B60R 22/20

(52) U.S. Cl. 280/801.2

(57) ABSTRACT

### Abstract of Disclosure

The invention relates to a seatbelt retractor located in a B-pillar of a vehicle. The cross section of the device is essentially U-shaped and when mounted in the B-pillar forms a cavity in combination with the B-pillar. The cavity comprises elements of a safety belt system. Further the invention relates to a system for reinforcing the B-pillar of a vehicle, comprising a device, the cross section of the device is essentially U-shaped and when mounted on the B-pillar forms a cavity in combination with the B-pillar, the cavity comprising elements of a safety belt system.

### Background of Invention

Field of the invention

The present invention relates to a seatbelt retractor mounting apparatus and a system for reinforcing a pillar of a vehicle.

Background of the invention

One of the things a B-pillar of an automotive vehicle is designed for is to handle the force applied by the safety belt system during collisions. In recent years cross-country trucks have become very popular. The compressive strength of the B-pillars is essential for personal safety in cross country trucks. However, the integration of safety belt devices in B-pillars weakens the compressive strength of the B-pillars. Also, devices provided on the B-pillar facing inwards might cause damage at the compression of a B-pillar.

One of the functions of the pillars of a vehicle, including the so-called B-pillar, is to provide support for the roof of the vehicle in the event that the vehicle is involved in an accident which may tend to crush the roof. Ways to enhance this important function can therefore be advantageous.

The most common safety belt devices comprise a safety belt retractor. The retractor is either provided on the floor of the vehicle or directly on the B-pillar, depending upon the specific design criteria for the safety belt system. In the case of a retractor mounted on the B-pillar, the retractor is mounted by a bracket or similar mounting method on the B-pillar.

A prior art mounting of a seat belt retractor on the B-pillar of a car body is shown in Figures 1A and 1B. A carrying device 1, a bracket, carries an automatic height adjusted retractor 2 mounted on a car body 3, more specifically the B-pillar 4 of a car body 3. The carrying device 1 is mounted on the car body 3 with two bolts 5. Carrying device 1 is very effective for securely mounting retractor 2 such that retractor 2 can fully carry out its functions. However, carrying device 1 is not designed to provide any additional structural integrity to B-pillar 4.

### Summary of Invention

An object of the present invention is to provide a device that reinforces the B-pillar of a vehicle, and more specifically reinforces the B-pillar regarding compressive forces. Another object is to provide a seatbelt retractor mounting apparatus.

These objects are achieved by the device, vehicle and system set forth in the appended claims.

The device according to the present invention has a cross section that is preferably essentially U-shaped and when mounted on the B-pillar forms a cavity in combination with the B-pillar, the cavity comprising elements of a safety belt system. The U-shape of the device in combination with the U-shape of the B-pillar forms a cavity that is more resistant to compressive forces than alone the U-shaped B-pillar. The cavity is preferably of a closed or substantially closed cross-section.

In order to facilitate the mounting of the safety belt system, elements of the safety belt system are preferably comprised in the device. Depending on what kind of safety belt system, the shifter or the retractor is comprised in the device.

According to one aspect of the invention the safety belt retractor is an automatic height adjusted retractor for automatic height adjustment. Since a retractor of this type requires more space than a regular retractor using a device according to the present invention is most beneficial.

Further, according to another aspect of the invention the device is provided with a predefined bend that in mounted position is directed outwards from the interior of a vehicle. If the compressive forces are large and the B-pillar bends, the device bends in the same direction as the B-pillar.

According to another aspect of the invention the device is provided with an elongate bore with one end thereof having a diameter larger than the width of said elongate bore for mounting purposes. A device according to the present invention comprising an automatic height adjusted retractor is quite heavy. In order to simplify the mounting the device is premounted on the car body. For example, a bolt is screwed into the B-pillar, the head of the bolt being small enough to slip through the one end of the elongated bore with the larger diameter but larger than the width of the rest of the bore. Thus, when finally fixing the device to the car body the device need not be lifted. Also, in order to decrease the weight, the device is made of high-tensile steel.

According to one aspect of the present invention a vehicle is provided comprising a device corresponding to the device disclosed above.

According to another aspect of the present invention there is provided a system for reinforcing the B-pillar of a vehicle comprising a device corresponding to the device disclosed above.

### Brief Description of Drawings

The invention is explained below in more detail with reference to the drawings, wherein:

Figure 1A is a perspective view of a device mounted on a car body, carrying an automatic height adjusted retractor, according to prior art.

Figure 1B shows the cross-section of the same prior art device and the B-pillar.

Figure 2A is a perspective view of a device, carrying an automatic height adjusted retractor, according to the present invention.

Figure 2B shows the cross-section of the same device and the B-pillar.

Figure 3 is an overall view of a car body with a device according to the present invention.

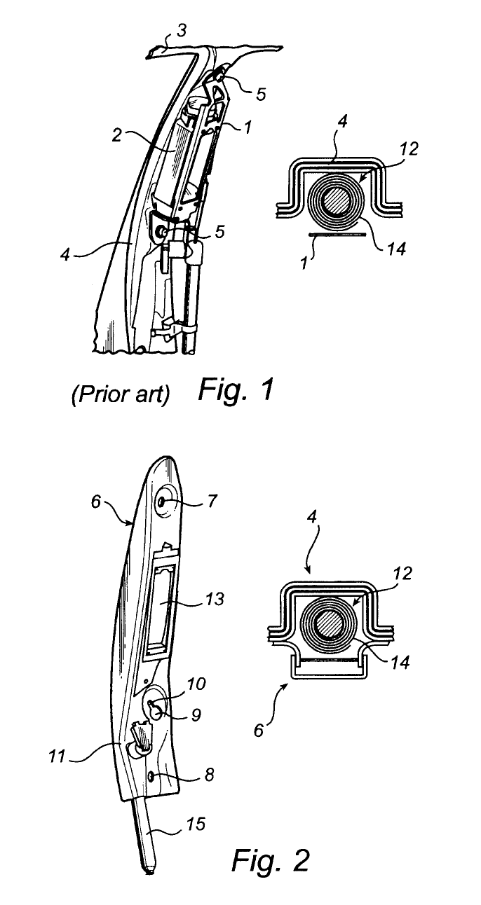

### Detailed Description

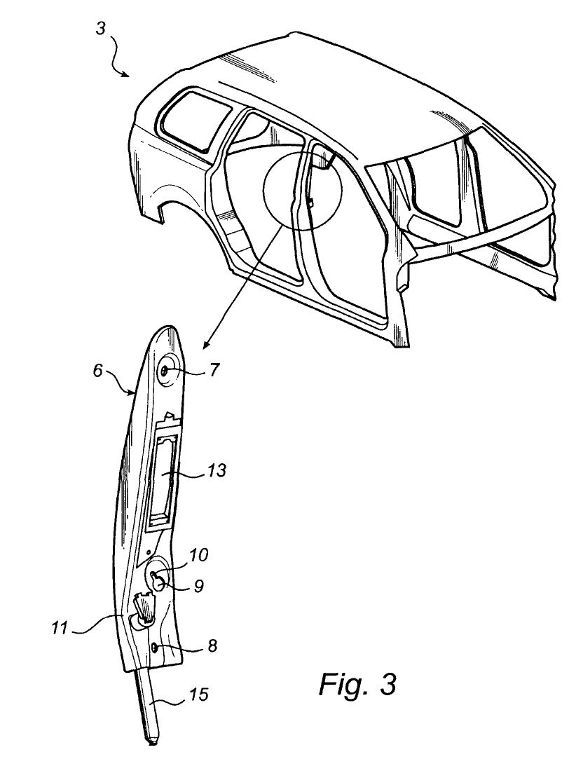

Figures 2A, 2B and 3 show a device 6, in this case a bracket, according to the present invention. In a preferred embodiment of the present invention the device 6 comprises an upper hole 7 and a lower hole 8 for fixing the device 6 onto the B-pillar 4. The device 6 also comprises an intermediate hole 9 with an elongate bore 10 extending from the upper part of the intermediate hole 9. When mounting the device 6, for instance, a bolt is screwed into the car body 3 and the device 6 is brought to its position and said bolt is fitted in the intermediate hole 9. When the head of the bolt has passed the hole 9 completely, the device 6 is moved downwards so that the elongate bore 10 slides down over the body of the bolt. When the bolt is in contact with the upper end of the elongate bore 10, the assembler does not need to carry the entire weight of the device 6 fixing the device via the upper 7 and the lower hole 8, respectively.

Further, in a preferred embodiment of the present invention, the device 6 comprises a predefined bend 11 following the contours of the B-pillar outwards seen from the interior of the car body. At compression of the B-pillar 4 the device 6 bends outwards together with the B-pillar 4 due to the predefined bend 11. Predefined bend 11 prevents device 6 from bending inwards at compression, preventing intrustion of device 6 into the passenger compartment of the vehicle.

In a preferred embodiment of the present invention the device 6 has attached to it a safety belt retractor 12 and suitable means (not shown) for holding the safety belt retractor 12 and an aperture 13 through which the safety belt 14 can pass. The aperture 13 height is preferably at least twice the width of the safety belt 14 in order to allow the use of an automatic height adjusted retractor. Further, the design of the device 6 is preferably such that it is essentially U-shaped. Thus, the safety belt retractor 12 is essentially embodied between the device 6 and the B-pillar 4. The U-shape of the device 6 in combination with the B-pillar defines a cavity which contributes considerably to the compressive strength of the B-pillar 4. The cavity is preferably of a closed or substantially closed cross section, enhancing said compressive strength.

Further, in a preferred embodiment of the present invention, the device 6 comprises a tensioning device 15. Said tensioning device 15 is a equipped with a pyrotechnic charge which is triggered by a collision of the vehicle or a rollover for tensioning of the safety belt 14. This tensioning aims to properly strap down the person using the safety belt 14 and thereby to avoid personal injuries due to bumping into the interior of the vehicle.

In an alternative configuration of a safety belt system, the retractor for the safety belt would be mounted on the floor of the vehicle. In such case, the device 6 mounted on the B-pillar holds a safety belt shifter, such as a D-loop (as known in the art) where the shifter is provided on a suitable sliding device (not shown) positioned at the same level as the aperture 13 for height adjustment.

For maximum tensile strength the device 6 is preferably made of high-tensile steel. A further advantage with using high-tensile steel is that it decreases the weight of the device 6 and hence the total weight of the vehicle, which is important considering fuel-consumption and mounting the device 6.

The foregoing is a disclosure of preferred embodiments for practicing the present invention. However, it is apparent that device incorporating modifications and variations will be obvious to one skilled in the art. Inasmuch as the foregoing disclosure is intended to enable one skilled in the art to practice the instant invention, it should not be construed to be limited thereby, but should be construed to include such modifications and variations as fall within its true spirit and scope.

Claims

1. A system for mounting one or more elements of a safety belt system with respect to a pillar of a vehicle body, said system comprising:
a device having an essentially U-shaped cross section, said device mounted on said pillar to form a cavity in combination with said pillar, said elements of said safety belt system mounted within said cavity.

2. A system according to claim 1, wherein said elements include a safety belt shifter.

3. A system according to claim 1, wherein said elements include a safety belt retractor.

4. A system according to claim 3, wherein said safety belt retractor is an automatic height adjusted retractor for automatic height adjustment.

5. A system according to claim 1, wherein the device is provided with a predefined bend that in mounted position is directed outwards from the interior of a vehicle.

6. A system according to claim 1, wherein the device is provided with an elongated bore with one end thereof having a diameter larger than the width of said elongated bore for mounting purposes.

7. A system according to claim 1, wherein the device is made of high-tensile steel.

8. A vehicle comprising:
a device located in a B-pillar, wherein the cross section of the device is essentially U-shaped and when mounted on the B-pillar forms a cavity in combination with the B-pillar, the cavity comprising elements of a safety belt system.

9. A vehicle according to claim 8, wherein said device comprises safety belt system elements.

10. A vehicle according to claim 8, wherein said device comprises a safety belt shifter.

11. A vehicle according to claim 8, wherein said device comprises a safety belt retractor.

12. A vehicle according to claim 11, wherein said safety belt retractor is an automatic height adjusted retractor for automatic height adjustment.

13. A vehicle according to claim 8, wherein said device is provided with a predefined bend that in mounted position is directed outwards from the interior of the vehicle.

14. A vehicle according to claim 8, wherein said device is provided with an elongate bore with one end thereof having a diameter larger than the width of said elongate bore for mounting purposes.

15. A vehicle according to claim 8, wherein said device is made of high-tensile steel.

16. A system for mounting one or more elements of a safety belt system with respect to a pillar of a vehicle body, said system comprising:
a device mounted on said pillar to form a cavity with substantially-closed cross section in combination with said pillar, said elements of said safety belt system mounted within said cavity.

17. A system according to claim 16, wherein said elements include a safety belt shifter.

18. A system according to claim 16, wherein said elements include a safety belt retractor.

19. A system according to claim 18, wherein said safety belt retractor is an automatic height adjusted retractor for automatic height adjustment.

20. A system according to claim 16, wherein the device is provided with a predefined bend that in mounted position is directed outwards from the interior of a vehicle.

21. A system according to claim 16, wherein the device is provided with an elongate bore with one end thereof having a diameter larger than the width of said elongate bore for mounting purposes.
